(19) United States
(12) Patent Application Publication
(10) Pub. No.: US 2014/0329126 A1
(43) Pub. Date: Nov. 6, 2014

(54) ELECTRODE AND BATTERY

(71) Applicant: Ballast Energy, Inc., Berkeley, CA (US)

(72) Inventors: Bryan Ho, Honolulu, HI (US); Bryan Ng, Sunnyvale, CA (US)

(21) Appl. No.: 14/333,390

(22) Filed: Jul. 16, 2014

Related U.S. Application Data
(63) Continuation of application No. PCT/US2013/021760, filed on Jan. 16, 2013.
(60) Provisional application No. 61/587,545, filed on Jan. 17, 2012.

(51) Int. Cl. H01M 4/36; H01M 10/0525

(52) U.S. Cl. CPC H01M 4/364; H01M 10/0525; H01M 2004/021
USPC 429/128; 427/487

(57) ABSTRACT

A lithium-ion battery generally includes an electrode pair, an electrolyte, and a separator. The electrode pair includes a first electrode and a second electrode, wherein the first electrode and the second electrode are of opposite polarity. The electrolyte is configured to allow movement of ions between the first electrode and the second electrode. The separator is between the first electrode and the second electrode. The first electrode generally includes an active layer and a current collector. The active layer comprises a plurality of composite electrode pellets that are non-hollow and include an active material and a binder material. The active layer is provided on a first side of the current collector. The active layer has an overall porosity of greater than approximately 40%. The overall porosity includes both intra-pellet porosity and inter-pellet porosity.

### PRIORITY CLAIM

The present application is a continuation of PCT/US2013/021760, filed Jan. 16, 2013, which claims priority to and the benefit of U.S. Provisional Patent Application 61/587,545, filed Jan. 17, 2012, the entire disclosures of which are incorporated herein by reference.

### BACKGROUND

In conventional lithium-ion batteries (e.g., those with a solid active material coated or layered onto a sheet-like current collector), electrodes are generally constrained to maximum active material thicknesses of 100-200 micrometers. This conventional electrode design promotes high electronic conductivity and high energy density at the expense of ion conduction in the electrolyte phase. However, at thicknesses greater than 100-200 micrometers, there may be significant unused capacity of active material, inhomogeneous charging and discharging, lower sustainable charge and discharge rates, and/or lower efficiency. A contributing limiting factor to electrode thickness in conventional batteries is low ion mobility within the pores of a composite electrode. Furthermore, conventional electrodes contribute to finished battery cell costs, both due to the high expenses that are incurred in the amount of current collector foil and separator film for increasing battery capacity with thin electrodes and in the manufacturing expenses associated with tight manufacturing tolerances for thin active material coatings.

### BRIEF DESCRIPTION OF THE DRAWINGS

FIG. 1 is a perspective view of a battery according to an exemplary embodiment.

FIG. 2A is a perspective view of a partial electrode stack according to an exemplary embodiment.

FIG. 2B is a perspective view of an electrode stack according to an exemplary embodiment.

FIG. 3A is a perspective view of an electrode plate according to an exemplary embodiment.

FIG. 3B is a is a schematic view of a portion of an active layer of the electrode plate according to the embodiment shown in FIG. 3A.

FIG. 3C is a schematic view of an electrode pellet of the active according to the embodiment shown in FIG. 3B.

FIG. 3D is a schematic view of a portion of an electrode pellet according to the embodiment shown in FIG. 3C.

FIG. 4 is a perspective view of an electrode frame according to an exemplary embodiment.

FIG. 5 is a perspective view of a battery according to another exemplary embodiment.

FIG. 6A is a perspective schematic view of an electrode stack according to an exemplary embodiment.

FIG. 6B is an exploded schematic view of the electrode stack according to the embodiment shown in FIG. 6A.

FIG. 7A is a schematic perspective view of an electrode according to an exemplary embodiment.

FIG. 7B is a schematic view of a portion of an active layer of the electrode according to the embodiment shown in FIG. 7A.

FIG. 7C is a schematic view of an electrode pellet of the active layer according to the embodiment shown in FIG. 7B.

FIG. 7D is a schematic view of a portion of the electrode pellet according to the embodiment shown in FIG. 7C.

FIG. 8 is a table listing various fabrication variables of an electrode according to an exemplary embodiment.

FIG. 9 is a graph of discharge voltage at various C rates for a battery according to an exemplary embodiment.

FIG. 10 is a graph of discharge voltage at various C rates for a battery having a conventionally-formed thick electrode.

FIG. 11 is a graph of mercury instrusion porosimetry data for electrodes according to a first exemplary embodiment, a second exemplary embodiment, and a first comparative example.

FIG. 12 is a graph of discharge voltage at constant current density for batteries according to a first exemplary embodiment, a second exemplary embodiment, and a first comparative example.

FIG. 13 is a graph of discharge voltage under constant discharge rate for batteries according to a first exemplary embodiment, a second exemplary embodiment, and a first comparative example.

FIG. 14 is a graph of discharge voltage under constant discharge rate for batteries according to exemplary embodiments having electrodes of varying thickness.

FIG. 15 is a schematic perspective view of a battery cell according to an exemplary embodiment.

FIG. 16 is a schematic perspective view of a four battery cells according to FIG. 15 that are interconnected.

### SUMMARY

According to an exemplary embodiment, an electrode for a lithium-ion battery generally includes an active layer and a current collector. The active layer comprises a plurality of composite electrode pellets that are non-hollow and include an active material and a binder material. The active layer is provided on a first side of the current collector. The active layer has an overall porosity of greater than approximately 40%. The overall porosity includes both intra-pellet porosity and inter-pellet porosity. The electrode is configured with a chemistry suitable for use in a lithium-ion battery.

According to an exemplary embodiment, a lithium-ion battery generally includes an electrode pair, an electrolyte, and a separator. The electrode pair includes a first electrode and a second electrode, wherein the first electrode and the second electrode are of opposite polarity. The electrolyte is configured to allow movement of ions between the first electrode and the second electrode. The separator is between the first electrode and the second electrode. The first electrode generally includes an active layer and a current collector. The active layer comprises a plurality of composite electrode pellets that are non-hollow and include an active material and a binder material. The active layer is provided on a first side of the current collector. The active layer has an overall porosity of greater than approximately 40%. The overall porosity includes both intra-pellet porosity and inter-pellet porosity.

According to an exemplary embodiment, a method is provided for manufacturing an electrode for a lithium-ion battery. The method generally includes: rotor granulating an active material and a binder material to form a plurality of composite electrode pellets that are non-hollow; mixing the composite electrode pellets with a binder material, a conductive additive, and a solvent to form an electrode paste; providing a current collector; providing the electrode paste on a first side of the current collector; and, curing the electrode past on the first side of the current collector to form an electrode with an active layer that comprises at last a portion of the composite electrode pellets. The active layer has an overall porosity that is greater than approximately 40% by volume, the overall porosity including both intra-pellet porosity and inter-pellet porosity.

### DETAILED DESCRIPTION

The present disclosure is directed to the construction and performance of electrodes for a battery, as well as batteries incorporating such electrodes. More particularly, the electrodes described herein are configured to provide improved performance at relatively high thicknesses as compared to conventional electrodes.

As described in further detail below, according to an exemplary embodiment, a lithium-ion battery includes one or more plate electrodes having a relatively thick, highly porous electrochemically active layer. For example, one or more of the positive and/or negative electrodes include a plurality of composite electrode pellets disposed generally within a metal-polymer composite grid or frame, together forming the rigid plate electrode. The composite electrode pellets generally include an electrochemically active material, binder, and conductive additive. According to other exemplary embodiments, the electrodes do not include a metal-polymer composite grid but are formed in other manners.

The inventors have discovered that a rigid, plate electrode of pre-fabricated composite electrode pellets disposed within a metal polymer composite grid may address challenges related to developing a high area specific capacity and allow for the production of thick electrodes that demonstrate excellent charging and discharging characteristics, provide excellent cycling performance, and are relatively simple to manufacture.

For example, use of composite electrode pellets provides for increased control over porosity of an electrode's active layer, with porosity being provided at both a first level between the material particles found within each composite electrode pellet (i.e., porosity within each pellet, or micro- or intra-pellet porosity) and also at a second level between the spherical pellets (i.e., porosity formed between the pellets, or macro- or inter-pellet porosity). By tuning the mean particle size and particle size distribution, high degrees of control over reticulated porosity and overall electrode porosity are achievable within an active layer. Greater control over porosity enables increasing the proportion of electrolyte phase within the active layer (as compared to conventional electrodes), which may be one method of increasing ion mobility in relatively thick electrodes to provide improved electrode charging/discharging characteristics.

As described in further detail below, according to an exemplary embodiment, the composite electrode pellets are formed through a rotor granulation process that combines the electrochemically active material, a binder material, and/or a conductive additive into the composite electrode pellets. The pellets are kneaded or mixed into an electrode paste with a conductive adhesion mixture that generally includes a solvent, additional binder material, and a conductive additive material. The electrode paste is then extruded or pressed into a metal-polymer composite grid framework and dried or cured to form a finished, rigid plate electrode.

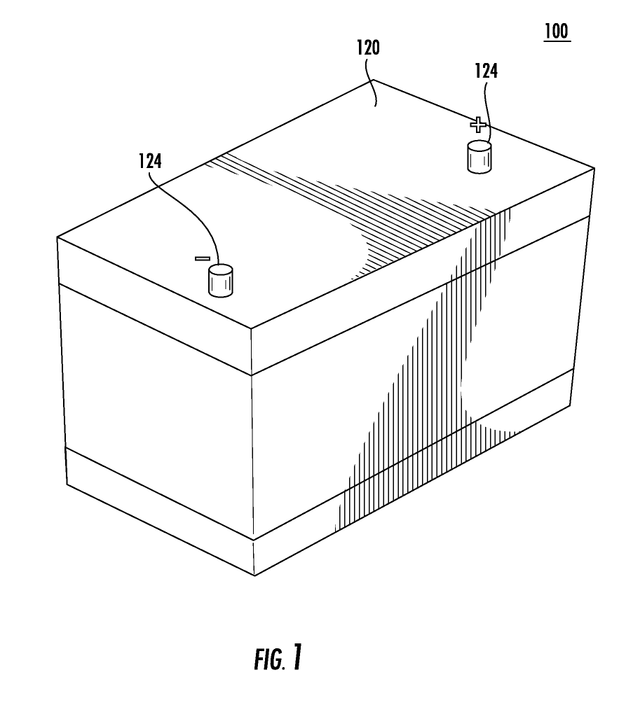

Referring to FIGS. 1-3D, according to an exemplary embodiment, a battery 100 generally includes a case 120, terminals 124 extending through the case 120, and one or more electrode pairs (e.g., with each pair including one positive electrode 150 and one negative electrode 160) disposed in the case 120 along with an electrolyte (not shown). As discussed below, each of the electrodes may be configured according to various characteristics including, for example, chemistry, composition, porosity, shape, and thickness.

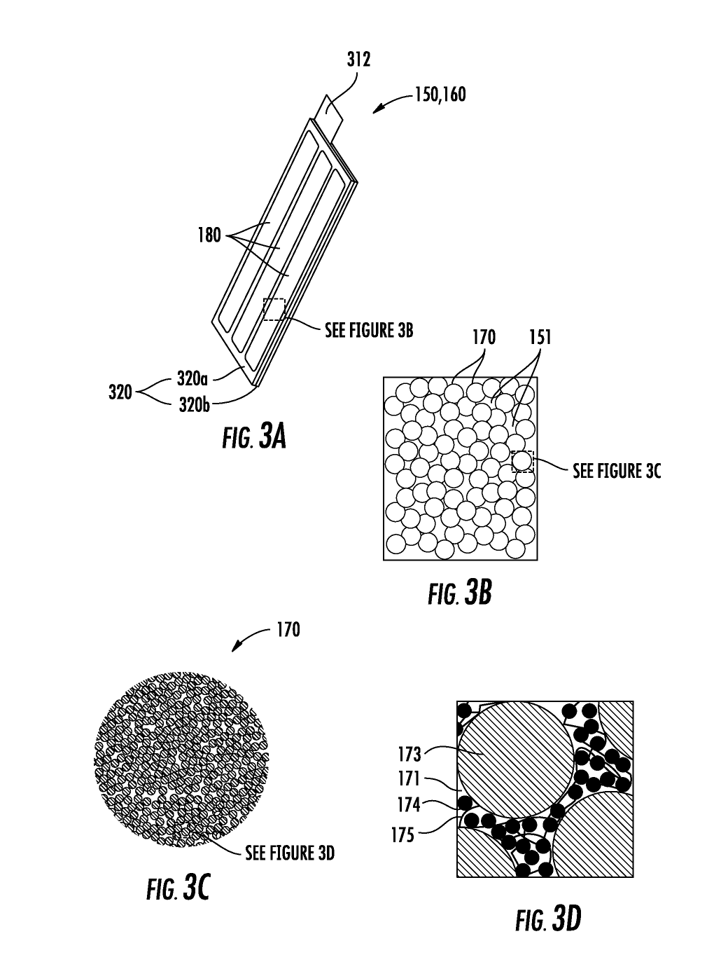

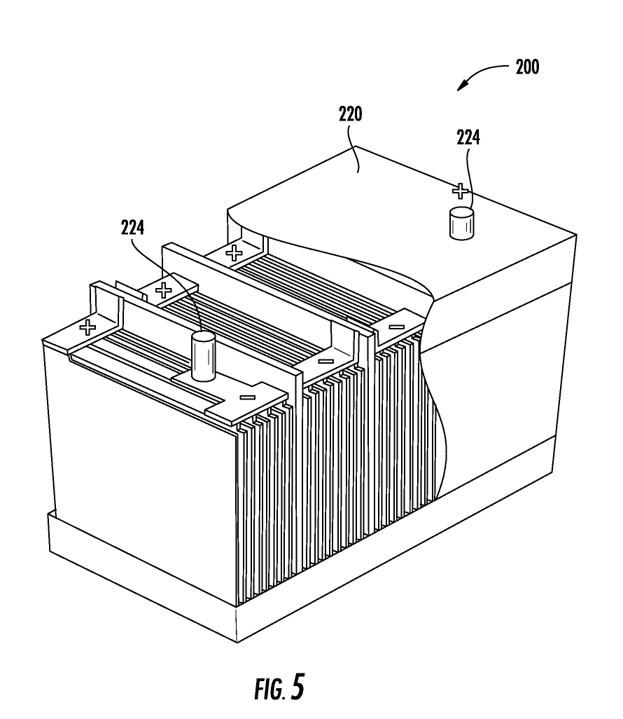

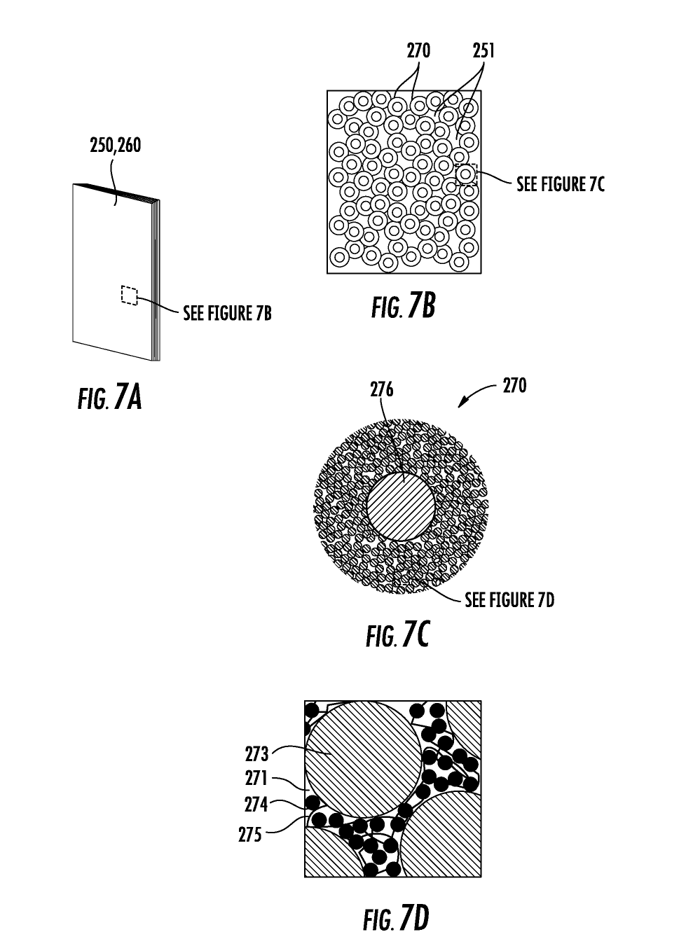

As shown in FIGS. 3A-3D, according to an exemplary embodiment, each electrode 150, 160 includes a plurality of composite electrode pellets 170 that are each formed of an active electrode material 173, additive conductive material 174, and a binder material 175. For example, as illustrated schematically in Figure D, the composite electrode pellets 170 include a lithium-active compound represented by circles 173, as well as filler materials like conductive additives represented by circles 174, and polymer binder material represented by lines 175. The electrodes have both microporosity or intra-pellet porosity indicated by reference numeral 171 and macroporosity or inter-particle porosity indicated by reference numeral 151. Pellets 170 are joined to form porous electrodes with the desired shape, microstructure, size, thickness, porosity, and conductivity. According to other exemplary embodiments, as shown in FIGS. 7C-7D, overall pellet 270 size may be tuned by the optional addition of an inert seed particle 276. It should be noted that reference numeral 170 is used to generally refer to composite electrode pellets, regardless of whether such pellets are for the positive electrode 150 or negative electrode 160, though it will be apparent that different materials (e.g., active materials 173) may be used depending on the electrode.

As discussed in further detail below, the battery 100 disclosed herein includes electrodes that are configured to incorporate the principles of both ion diffusion through the pores of a solid composite electrode, as well as and ion diffusion through an interconnected electrolyte phase with a low solid content. These diffusion mechanisms occur in different regions of an electrode due to the presence of porosity that exists on two different length scales. The first level of porosity, which will be referred to herein as microporosity or intra-pellet porosity 171, supports ion diffusion through a porous composite electrode phase saturated with electrolyte (i.e., within an electrode pellet 170). For example, microporosity exists in a non-hollow composite cathode pellet comprising an active material, such as lithium-iron phosphate, a binder, and a conductive carbon additive. It should be understood that non-hollow pellets may be porous (i.e., having voids, pores, gaps, etc. therein) but do not include an intentionally created, generally central void.

The second level of porosity, which will be referred to herein as macroporosity or intra-pellet porosity 151, supports ion diffusion through an interconnected electrolyte phase with a low solid content (i.e., between electrode pellets). For example, macroporosity exists in large, interconnected voids between solid portions of an electrode, and includes electrolyte, such as a mixture of ethylene carbonate, dimethyl carbonate, and lithium hexafluorophosphate.

According to an exemplary embodiment, each positive electrode 150 includes a plurality of composite electrode pellets 170, each of which includes a positive active material 173, a conductive additive 174, and a polymer binder 175. According to an exemplary embodiment, the positive active material is a lithium compound that functions to electrochemically react with lithium ions. The lithium compound may, for example, be LiFePO₄. According to other exemplary embodiments, the intercalation compound may be, but is not limited to, LiCoO₂, LiCo₁₋ₓMₓO₂ (where M is a transition metal or combination of transition metals such as Ni, Al, Mn, Fe, etc., and where x is between approximately 0 and 1), LiCo_{1-x-y}M1ₓM2_{y}O₂ (where M1 and M2 are transitional metals or combination of transition metals such as Ni, Al, Mn, Fe, etc., x is between approximately 0 and 1, and y is between approximately 0 and 1), LiFePO₄ and its variants (carbon coated, doped, co-crystalline), LiMPO₄ (where M is a transition metal or combination of transition metals such as Ni, Al, Mn, Fe, etc.), LiMn₂O₄, LiMn₂₋ₓMₓO₄ (where M is a transition metal or combination of transition metals such as Ni, Al, Mn, Fe, etc., and where x is between approximately 0 and 1), LiMnO₂, LiMn₁₋ₓMₓO₂ (where M is a transition metal or combination of transition metals such as Ni, Al, Mn, Fe, etc., and where x is between approximately 0 and 1), (Li₂MnO₃)ₓ(LiMO₂)₁₋ₓ (where M is a transition metal or combination of transition metals such as Ni, Al, Mn, Fe, etc., and where x is between approximately 0 and 1) or a combination thereof.

According to an exemplary embodiment, the conductive additive 174 of the positive composite electrode pellets functions to enhance the electrical conductivity of the positive electrode 150 and/or composite electrode pellets 170 thereof. The conductive additive may, for example, be carbon black. According to other exemplary embodiments, the conductive additive may be graphite, carbon nanotubes, graphene, carbon fiber, or powder, fiber, rods, wires of stable metals such as nickel, gold, silver, titanium, aluminum, tungsten, or a combination thereof.

According to an exemplary embodiment, the polymer binder 175 of the positive electrode pellets functions to bind together the positive active compound and/or conductive additive into a unitary structure. The polymer binder may be a modified styrene butadiene rubber. According to other exemplary embodiments, the polymer binder may be polyethylene, polypropylene, polyvinylidene fluoride, polytetrafluoroethylene, polystyrene, polybutadiene, polyvinyl alcohol, other natural or synthetic latex rubbers, or a combination thereof.

According to an exemplary embodiment, the positive active material forms approximately 65%-98% by weight (e.g., 85-95%, or 88-93%) of the composite electrode pellets 170 of the positive electrode 150. The conductive additive forms approximately 1%-20% by weight (e.g., between approximately 1% and 10%, or approximately 5%) by weight of the composite electrode pellets 170. The binder material forms less than approximately 15% by weight (e.g., less than approximately 5%, or approximately 2%-3%) of the composite electrode pellets 257. For example, the composite electrode pellets 170 of the positive electrode 150 may include, by weight, approximately 85% active material (e.g., LiFePO₄), approximately 10% conductive additive (e.g., carbon black), and approximately 5% binder material (e.g., modified styrene butadiene rubber). According to another exemplary embodiment, the composite electrode pellets 170 of the positive electrode 150 include, by weight, approximately 90% active material (e.g., LiFePO₄), approximately 5% conductive additive (e.g., carbon black), and approximately 5% binder (e.g., modified styrene butadiene rubber).

According to other exemplary embodiments, the positive electrode 150 may have a different material composition. Other material compositions may include, for example, more or fewer types of component materials (e.g., omitting one or both of the conductive additive or polymer binder, or adding another type of material), different proportional makeup, or materials for different battery chemistries. Sodium carboxyl methyl cellulose, or similar additives may be added to enhance rheological stability. Component content of the positive electrode 150 may be determined according to various considerations including, for example, desired cell voltage, material cost, electrode reaction kinetics, mechanical requirements such as strength and durability, ease of manufacturing, chemical stability and compatibility, electrochemical cycle life, shelf life, availability, and environmental, health, and safety factors.

According to an exemplary embodiment, each negative electrode 160 includes a plurality of composite electrode pellets 170, each of which includes a negative active material or compound 153, a conductive additive 154, and a polymer binder 155. According to an exemplary embodiment, the compound of the negative active material is a material that functions to electrochemically react with lithium ions (i.e., cycle, intercalate, etc.). The negative active material may, for example, be a carbonaceous material, such as graphite, amorphous carbon, hard carbon, or mesoporous carbon microbeads. According to other exemplary embodiments, the lithium compound may be, but is not limited to, Li, LiAl, Li₉Al₄, Li₃Al, Zn, LiZn, Ag, LiAg, Li₁₀Ag₃, B, Li₅B₄, Li₇B₆, Ge, Li_{4.4}Ge, Si, Li₁₂Si₇, Li₂₁Si₈, Li₁₃Si₄, Li₂₁Si₅, Sn, Li₅Sn₂, Li₁₃Sn₅, Li₇Sn₂, Li₂₂Sn₅, Sb, Li₂Sb, Li₃Sb, Bi, LiBi, Li₃Bi, SnO₂, SnO, MnO, Mn₂O₃, MnO₂, Mn₃O₄, CoO, NiO, FeO, LiFe₂O₄, TiO₂, LiTi₂O₄, Li₄Ti₅O₁₂ and glass with a tin-boron-phosphorous-oxygen compound, or a combination thereof.

According to an exemplary embodiment, the conductive additive 154 of the negative active material functions to enhance the electrical conductivity of the negative electrode 160. The conductive additive may, for example, be carbon black. According to other exemplary embodiments, the conductive additive may be graphite, carbon nanotubes, graphene, carbon fiber, or powder, fiber, rods, wires of stable metals such as nickel, gold, silver, titanium, aluminum, tungsten, copper or a combination thereof.

According to an exemplary embodiment, the polymer binder 155 of the negative active electrode functions to bind together the positive active compound and/or conductive additive into a unitary structure. The polymer binder may be a modified styrene butadiene rubber. According to other exemplary embodiments, the polymer binder may be polyethylene, polypropylene, polyvinylidene fluoride, polytetrafluoroethylene, polystyrene, polybutadiene, styrene butadiene rubber, polyvinyl alcohol, other natural or synthetic latex rubbers, or a combination thereof.

According to an exemplary embodiment, the negative active material forms approximately 65%-98% by weight (e.g., 85-98%, or 90%-96%) of the composite electrode pellets 170 of the negative electrode 160. The conductive additive forms approximately 0%-20% by weight (e.g., less than approximately 10%, or less than approximately 5%) by weight of the composite electrode pellets 170. The binder material forms less than approximately 15% by weight (e.g., less than approximately 5%, or approximately 2%-3%) of the composite electrode pellets 170. For example, the composite electrode pellets 170 of the negative electrode 160 may include, by weight, approximately 92% active material (e.g., graphite), approximately 3% conductive additive (e.g., carbon black), and approximately 5% binder (e.g., modified styrene butadiene rubber). According to another exemplary embodiment, the composite electrode pellets 170 of the negative electrode 160 include, by weight, approximately 94% active material (e.g., graphite), approximately 3% conductive additive (e.g., carbon black), and approximately 3% binder (e.g., modified styrene butadiene rubber).

According to other exemplary embodiments, the negative electrode 160 may have a different material composition. Other material compositions may include, for example, more or fewer types of component materials (e.g., omitting one or both of the conductive additive or polymer binder, or adding another type of material), different proportional makeup, or materials for different battery chemistries. Sodium carboxylmethyl cellulose, or similar additives may be added to enhance rheological stability. Component content of the negative electrode 160 may be determined according to various considerations including, for example, desired cell voltage, material cost, electrode reaction kinetics, mechanical requirements such as strength and durability, ease of manufacturing, chemical stability and compatibility, electrochemical cycle life, shelf life, availability, and environmental, health and safety factors.

According to an exemplary embodiment, the composite electrode pellets 170 of the positive electrode 150 and/or negative electrode 160 are formed through a rotor granulation process, for example, as described below with reference to Examples 1 and 2. According to other exemplary embodiments, the composite electrode pellets may be formed through other processes including, but not limited to, shear granulation, spray granulation, spray agglomeration, high shear agglomeration, fluid bed coating, pan coating, wurster coating, rotor coating and granulation, pan coating, extrusion and spheronization, layering, rotor pelletizing, encapsulation, vibration drip, spray drying, melt granulation and wet granulation.

According to an exemplary embodiment, the composite electrode pellets 170 may be generally spherically-shaped (i.e., having a ratio between major and minor dimensions of less than approximately 1.5). According to other exemplary embodiments, the composite electrode pellets 170 may be shaped in other manners, such as generally cylindrically-shaped (e.g., having a ratio between length and diameter of less than approximately 3:1, such as less than approximately 2:1). According to still other exemplary embodiments, the composite electrode pellets 170 may be shaped in other manners, such as generally platelet shaped (e.g., having a ratio between height and diameter of less than approximately 1:3, such less than approximately 1:2). It should be recognized that although general shapes (e.g., spherical, cylindrical, and platelet) are described, that the electrodes 150 and/or 160 may include composite electrode pellets 170 falling outside the specified shapes (e.g., within specified tolerances).

According to an exemplary embodiment, the composite electrode pellets 170 are sized according to various considerations, including, for example, component material characteristics, balancing of local charge capacity between the positive electrode 150 and negative electrode 160, electrochemical reaction optimization, and electrode porosity. Further considerations in determine composite electrode size include mass transport kinetics, electrode, cost, ease of processing, and ease of handling.

According to an exemplary embodiment, the mean pellet size (e.g., nominal diameter, thickness, etc.) is configured to be greater than approximately three times the nominal particle size of raw active material, or other material (e.g., binder, conductive additive), used to form the composite electrode pellet. For example, a composite electrode pellet may be formed with a graphite active material that is supplied with a mean particle size of approximately 8 micrometers and have a minimum diameter of approximately 24 micrometers. It should be recognized that the minimum mean pellet size may vary according to the size of particles supplied for each component material.

According to an exemplary embodiment, the mean pellet size is configured to be less than approximately 15-20% of the total active layer thickness (described in further detail below). Configured in this manner, the electrodes prevent or limit localized capacity imbalance between the positive and negative electrodes, for example, from a missing pellet to prevent or mitigate lithium plating that might otherwise occur for low potential negative active materials, such as graphite, where capacity of the positive electrode exceeds that of the negative electrode. For non-carbonaceous negative active materials, or those active materials otherwise having higher cycling potentials further above a lithium plating potential, the mean pellet size may be increased relative to the total active layer thickness.

According to an exemplary embodiment, the pellets 170 may be sized to have a radial thickness dimension that is approximately equal to the maximum desired diffusion distance (e.g., the optimized thickness for the electrode if configured as a layer disposed on a current collector, which is approximately 25-200 micrometers for some lithium ion chemistries). The composite electrode pellets may be configured, for example, to have a generally uniform composition having a radius less than or equal to the approximate optimized thickness of a comparable conventional electrode (i.e., material composition, density, porosity, etc.).

According to an exemplary embodiment as shown in FIGS. 7A-7D, the composite electrode pellets 270 may instead be fabricated as a coated sphere, where an inert seed particle 276 is coated with the electrode material (i.e., active material 273, conductive additive 274, and binder material 275) at a thickness less than or equal to the approximate optimized thickness of a comparable conventional electrode. In this case, the radial thickness indicates the thickness of the coating layer, such that the total pellet radius is the sum of the seed particle radius and the electrode coating layer thickness.

The composite electrode pellet 270 may be formed with a coating process for an inert seed particle 276 of a material outlined below. Coating processes may involve additional post-treatment steps, such as rinsing with solvents or baking in hot or dry environments. The preferred method of fabrication may be determined according to various criteria such as fabrication ease, pellet density, pellet compositional uniformity, pellet size uniformity, availability, efficiency, risk, cost, scalability, and final product performance.

The porosity within a pellet acts as the microporosity or intra-pellet porosity 171 (or 271), defined previously. The gaps between adjacent pellets form the macroporosity or inter-particle porosity 151 (or 251), and can be tuned to varying degrees to adjust the proportion of electrolyte phase. Pellets 270 that would otherwise involve inefficient radial thickness of active material (e.g., greater than 25-200 micrometers) may be fabricated using inexpensive and inert seed particles. Seed particles 276 can comprise, but are not limited to polyethylene, polypropylene, polyvinylidene fluoride, glass, cenospheres, zirconia, polytetrafluoroethylene, stable metals which may include aluminum, copper, stainless steel, gold, silver, nickel, tungsten, titanium, or a combination thereof. For example, a 150 micrometer coating of active electrode material (e.g., a lithium-active compound 273, as well as filler materials like conductive additives 274 and polymer binders 275) can be applied on top of seed particles 256 that have a 100 micrometer radius to achieve a total pellet radius of 250 micrometers.

According to an exemplary embodiment, as discussed in further detail below, the mean pellet size is configured according to desired electrode porosity (i.e., porosity of the active layer, discussed in further detail below). Furthermore, the pellet size is configured according to desired size distribution about a selected mean pellet size (e.g., standard deviation of approximately ½ the mean). By controlling the mean size and size distribution of the composite electrode pellets forming an electrode, greater flexibility is provided for achieving desired porosity of the electrode itself. Additionally, pellets may be provided in more than one size (e.g., bi-modal or multi-modal distribution), thereby providing even further control over porosity based on the relative size (with a desired sized distribution) and relative quantities of the different sizes of particles. For example, as discussed in further detail below, increasing overall electrode porosity may provide for increased capacity utilization of the electrodes.

According to other exemplary embodiments, pellets 257 may be provided in other manners to alter, among other considerations, desired diffusion distances and porosity characteristics. Smaller or larger pellets may provide for shorter or longer diffusion distances, such that more or less active material of the pellets may absorb or release ions.

According to an exemplary embodiment, the pellets 170 are joined together to form the electrode 150, 160 of a desired shape, size, thickness, porosity, and conductivity. For example, the composite electrode pellets 170 may be combined with a conductive adhesion mixture, which is then added to an electrode frame 300 (e.g., composite grid) and dried or cured to form a rigid plate electrode 150, 160.

According to an exemplary embodiment, the pellets 170 are joined together to form an active layer 180 of an electrode (e.g., 150, 160). For example, the composite electrode pellets may be kneaded or otherwise mixed with a conductive adhesion mixture into an electrode paste for joining the composite electrode pellets together and to a current collector (discussed in further detail below). The conductive adhesion mixture generally includes a solvent, binder, and a conductive additive, and may also include a mechanical filler. The conductive adhesion mixture may be preformed and then mixed with the electrode pellets, or the component ingredients of the conductive adhesion mixture may be provided individually or in submixtures for mixing or kneading with the electrode pellets to form the electrode paste. The electrode paste may be made to any desirable viscosity through the addition of solvent in order to best suit processing requirements, such as adhesion strength, uniformity of coating, ease of manufacturing, chemical stability and compatibility, electrochemical performance, cost of materials, and environmental and safety factors. According to other exemplary embodiments, the conductive adhesion mixture may include more, fewer, or different subcomponents.

According to an exemplary embodiment, the polymer binder of the conductive adhesion mixture may be a modified styrene butadiene rubber. According to other exemplary embodiments, the polymer binder may be polyethylene, polypropylene, polyvinylidene fluoride, polytetrafluoroethylene, polystyrene, polybutadiene, styrene butadiene rubber, polyvinyl alcohol, other natural or synthetic latex rubbers, or a combination thereof. Sodium carboxylmethyl cellulose additives may be included for enhanced rheological properties.

According to an exemplary embodiment, the conductive additive of the conductive adhesion mixture may, for example, be carbon black. According to other exemplary embodiments, the conductive additive may be graphite, carbon nanotubes, graphene, carbon fiber, or powder, fiber, rods, wires of stable metals such as nickel, gold, silver, titanium, aluminum, tungsten, or a combination thereof. As the role of the conductive adhesion mixture is mainly to transport charge across macroscopic distances, the conductive additive employed in the conductive adhesion mixture may be different in chemistry and morphology from that used in the pellet, where charge transport is mainly across microscopic distances.

According to an exemplary embodiment, the solvent of the conductive adhesion mixture may be selected in consideration of the binder material of the composite electrode pellets, such that the pellet binder is non-soluble or only partially soluble in the paste solvent to maintain the integrity of the pellet during pasting. For example, a suitable solvent may be water. According to other exemplary embodiments, the solvent may be a acetonitrile, acetone, n-methylpyrroldinone, similar material, or a combination thereof. According to other exemplary embodiments, the solvent configured (i.e., selected from various materials and provided in sufficient relative quantity) to dissolve the binder (of the conductive adhesion mixture) in the conductive adhesion mixture. According to still other exemplary embodiments, the solvent may be configured to dissolve the binder of the pellet surface without affecting the general mechanical integrity of the composite electrode pellet, thereby allowing for the formation of a unitary electrode without additional binder in the conductive adhesion mixture. It should be noted that, as discussed in further detail below, the solvent of the conductive adhesion mixture is substantially removed during processing of the finished electrode (e.g., drying or curing), such that the solvent is not present, or is present in only limited quantities, in the finished electrode.

According to an exemplary embodiment, the mechanical filler is configured (i.e., selected) from various materials and provided in sufficient quantity) to prevent or mitigate spallation and/or cracking. For example, the mechanical filler may be a chopped polypropylene fiber. According to other exemplary embodiments, the mechanical filler may be a fibrous floc such as polyethylene, polypropylene, polyvinylidene fluoride, glass, polytetrafluoroethylene, stable metals which may include aluminum, copper, stainless steel, gold, silver, nickel, tungsten, titanium, or a combination thereof.

According to an exemplary embodiment, the electrode paste is engineered with a relatively low solvent content to mitigate cracking during drying or curing of the electrode paste, for example, to promote uniformity of the active layer 180. For example, the electrode pellets and conductive adhesion mixture are provided in quantities to provide a wet mixture with an overall composition by relative weight of pellets at of approximately 40% to 80% (e.g., approximately 50% to 70%, approximately 55% to 65%), binder at approximately 0% to 5% (e.g., approximately 0.1% to 3%, approximately 0.5% to 1.5%), conductive additive at approximately 0% to 10% (e.g., approximately 0.5% to 5%, approximately 1% to 3%), mechanical filler at approximately 0% to 2% (e.g., approximately 0.05% to 1%, approximately 0.1% to 0.4%), and solvent at approximately 20% to 55% (e.g., approximately 30% to 45%, approximately 34% to 40%). [0050] As referenced above, according to an exemplary embodiment, the electrode paste (i.e., composite electrode pellets and conductive adhesion mixture) is added to the electrode frame 300 illustrated in FIG. 4. The paste is then dried or cured to form an active layer 180 of a rigid plate electrode 150, 160.

According to an exemplary embodiment, as discussed in further detail below, the electrode frame 300 generally includes a metallic current collector 310 coupled to a polymer frame 320. For example, the electrode frame 300 may be a 3-layer laminate structure with a thin, metallic current collector 310 disposed between two halves 320a, 320b of a windowed, polymer frame 320. The electrode frame 300 generally provides the structure of the electrode. The electrode frame 300, and more particularly, the polymer frame 320, generally defines the overall shape and size (i.e., length, width, and thickness) of the electrode. For example, for batteries configured as a replacement or alternative for conventional lead acid batteries, the electrode frame 300 may have a rectangular shape with a length and width comparable to that used in such lead acid batteries. According to other exemplary embodiments, the electrode frame 300, and polymer frame 320 thereof, may have other size and or shape as may be desired for a particular application. According to still other exemplary embodiments, including but not limited to those described in further detail below, electrodes may be formed in other manners that do not include the electrode frame 300.

According to an exemplary embodiment, the polymer frame 320 is configured to provide structure to the electrode 150, 160, before and after curing or drying of the electrode paste. The frame 320 is made from an inert material, such as a polymer, including, for example polyethylene, polypropylene, polyvinylidene fluoride, polytetrafluoroethylene, fluorinated ethylene propylene, perfluoroalkoxy resin, or a combination thereof. The polymer forming the frame 320 may additionally be filled with a solid phase for increased stiffness, hardness, or electronic conductivity by the additional of glass beads, glass fibers, carbon black, carbon fibers, carbon nanotubes, metal powder, or metal fibers.

According to an exemplary embodiment, the two halves 320a, 320b of the polymer frame 320 are bonded to one another across the central current collector 310 to define the electrode frame 300. For example, the two halves 320a, 320b may be coupled to each other by a thermal weld, chemical weld, adhesives, positive coupling features, any suitable combination thereof, or any other suitable method. For example, thermal welding includes application of a local heat source or ultrasonic vibrations. Chemical welding includes, for example, use of a solvent causing partial dissolution of the polymer material of the two halves 320a, 320b of the polymer frame 320. Adhesives may include, for example, a modified styrene butadiene rubber, polyvinylidene fluoride, polytetrafluoroethylene, polystyrene, polybutadiene, styrene butadiene rubber, polyvinyl alcohol, other natural or synthetic latex rubbers, or a combination thereof. Positive coupling features may include tabs or protrusions configured to engage complementary recesses or surfaces of the other frame half.

According to an exemplary embodiment, the polymer frame 320 may be made by any suitable method including, for example, injection molding, stamping, machining, die-cutting, etc. Furthermore, each half of the polymer frame may be manufactured individually, or as part of a continuous strip.

According to an exemplary embodiment, the frame 320 defines one or more openings 322 (e.g., open area, cutout, window, recess, aperture, etc.) that is configured to receive the paste (i.e., mixture of composite electrode pellets and conductive adhesion mixture therein). More particularly, prior to receiving the paste, the current collector 310 is exposed in the opening 322 of the frame 320, such that the frame 320 and the current collector 310 generally define one or more recesses or cavities to receive the paste, which is then dried or cured to be coupled to the current collector 310 and/or frame 320 to form a rigid plate electrode 150, 160.

According to an exemplary embodiment, the electrode paste may be provided in openings 322 in the polymer frame 320 on both sides of the current collector 310 (i.e., in openings 322 defined by both halves 320a, 320b of the polymer frame 320), such that an active layer 330 may be coupled to and provided on first and second sides of the current collector 320 (i.e., a bidirectional electrode construct). Complementary cathode and anode plates 150, 160 can then be stacked in an alternating fashion, and allow for a single plate to undergo electrochemical reactions on both sides of the main current collector. This would effectively allow for a single electrode plate to be double the effective thickness as compared to an electrode that was not created in a bidirectional electrode construct. This is especially effective in conjunction with macroporosity since it allows variations in electrode thickness to be effectively used, thereby reducing manufacturing tolerance requirements.

According to an exemplary embodiment, the polymer frame 320 may include one or more openings 322 (FIG. 4 illustrates three openings 322) configured to receive the electrode paste therein to form the active layer. The openings 322 may be configured according to several considerations, including total open area of the polymer frame 320, number, shape, pattern, and relative configuration (e.g., size, location, depth, etc.) to an opposing electrode.

According to an exemplary embodiment, the openings 322 collectively define an open area of approximately 60% to 95% (e.g., 80%) of the planar surface of the electrode frame 300. By providing multiple openings 322, the strength and rigidity of the polymer frame 320, and thereby the rigid plate electrode 150, 160, may be increased by placing strengthening members between openings 322.

According to an exemplary embodiment, as shown in FIG. 4, the openings 322 are generally rectangular. According to other exemplary embodiments, the openings 322 may be another quadrilateral shape with each side measuring greater than approximately 5 millimeters, or other polygonal shape (e.g., triangles, pentagons, hexagons, heptagon, octagon, or a polygon with more than 8 sides). The openings 322 may include fillets (e.g., in corner regions of the polygonal shape) to remove sharp angles that may degrade the local mechanical integrity of the electrode plate or active layer 310. For example, each fillet may have a radius of greater than approximately 500 micrometers.

According to still further embodiments, the openings 322 may be provided in repeated patterns. For example, several openings having one or more shapes described above may be provided in a repeated pattern (e.g., about central axes defining the planar face of the frame 300).

According to an exemplary embodiment, the open areas 322 are additionally located to generally align with (e.g., face, coincide, mirror, etc.) similar open areas of an opposing electrode of opposite polarity (e.g., such that active portions of opposing electrodes are matched). According to another exemplary embodiment, the openings 322 of the negative electrode 160 are slightly oversized relative to the openings 322 of the positive electrode 150 to, for example, accommodate slight misalignment of the electrodes and prevent lithium plating that may result from localized overcapacity of the positive electrode 150. According to other exemplary embodiments the anode cutouts are at least of equal size to the corresponding cathode cutouts.

According to an exemplary embodiment, the polymer frame 320 is configured to provide the active layer 330 with a desired thickness (discussed in further detail below). For example, the depth of the open areas 322 (e.g., the thickness of each half 320a, 320b of the polymer frame 320) to the current collector 310 generally determines the eventual thickness of the active layer 310 formed therein. Considerations in determining electrode thickness (i.e., active material 180 thickness) are discussed in further detail below.

According to an exemplary embodiment, the frame 300 may include further features (not shown), for example, to accommodate electrode manufacturing, such as the addition or subtraction of handling tabs, squares, corners, rounded edges, or other constructs.

According to an exemplary embodiment, the current collector 310 is configured to provide electrical contact between the electrochemically active portions of the electrode to an external current collecting terminal. Suitable materials for the current collector include stable metals such as nickel, gold, silver, titanium, aluminum, tungsten, copper or a combination thereof. The current collector may comprise a single metal, a coated metal (e.g., nickel-coated steel), a metal plated polymer, or a polymer-metal composite.

According to an exemplary embodiment, the current collector 310 may also have a continuous (i.e., sheet, foil) surface with generally no open area, or a non-continuous surface having a patterned or distributed open area of approximately 0% to 80% (e.g., approximately 30%-50%, or approximately 40%). For example, the current collector 310 may be an expanded sheet. According to other exemplary embodiments, the current collector 310 may be a perforated sheet, foam, woven wire mesh, nonwoven collection of wires, solid sheet or other configuration suitable to provide a low resistance path for electrons. By providing a current collector with an open area, the active layer 310 may be formed in continuous segments across a midplane of the electrode, thereby adding mechanical integrity to a finished rigid electrode plate 150, 160 and/or enhancing adhesion between the current collector 310 and active layer 330.

According to an exemplary embodiment, the current collector may be additionally coated or prepared to increase the ease of processing for additional steps. For example, the current collector may be coated with a conductive adhesion mixture comprising polymer binder and carbon conductive additive described previously, which may make a paste-coating of a pellet mixture easier to apply.

According to an exemplary embodiment, the current collector 310 may be of any geometry determined according to cost, mechanical stability, and/or electrical conductivity as may be required by a particular application. For example, the current collector 310 may be shaped and/or sized to extend substantially entirely across each of the openings 322 in the polymer frame 320. For embodiments having a rectangular shape, the current collector has an overall rectangular shape and size generally corresponding to that of the electrode frame 300 and polymer frame 320.

According to an exemplary embodiment, the current collector 310 may include further features to enable electrical connection between electrodes and/or to a terminal of the battery. For example, the current collector 310 may include features such as a tab 312 that extends beyond the polymer frame 320. Other geometric features of the current collector may include the addition or subtraction of tabs, squares, corners, rounded edges, or other constructs. The current collector may also include geometric features affecting to cost, mechanical stability, and/or electrical conductivity.

According to an exemplary embodiment, each rigid electrode plate is formed by providing the electrode paste (i.e., mixture of composite electrode pellets and conductive adhesion mixture) in the openings 322 of the frame 300. The electrode paste is extruded or pressed into the one or more openings 322, filling the openings 322 to the depth of the polymer frame 320. Sufficient force may be applied to the paste to remove large voids and provide good electrical contact between the electrode pellets but does not significantly deform or otherwise degrade the primary structure of the electrode pellets. For single-sided electrodes (i.e., those having an active layer on only one side of the current collector 310), the frame 310 may lie flat on a cotton, rubber, polymer, or steel belt and the electrode paste extruded into the openings 322 from above the belt. The belt prevents the paste from exiting reverse side by the belt. For double-sided electrodes (i.e., those having an active layer on both sides of the current collector 310), each side of the electrode may be pasted individually (e.g., similar to single-sided electrodes), both sides may be pasted from a single direction (e.g., similar to single-side electrodes with electrode paste flowing through the current collector), or paste may be extruded concurrently into openings 322 on both faces of the frame. In each instance (i.e., for both single and double sided electrodes), precise leveling of the electrode paste may be accomplished by metering a known volume or mass of the electrode paste and spreading it evenly across the electrode frame 300, or by over-pasting a grid and removing excess material off of either face of the pasted electrode frame 300.

According to an exemplary embodiment, after the electrode paste is applied to the frame 300, the pasted grid is then dried at a temperature and for a duration sufficient to effectively remove the solvent from the electrode paste, so as to cure the electrode paste into a solid active layer 180. For example, according to exemplary embodiments where the solvent is water, a drying temperature of between approximately 40 and 150 degrees Celsius 40 C and 150 C. It should be noted that maximum drying temperature may be limited to prevent any polymeric material (e.g., pellet binder, conductive adhesion mixture binder, or frame) from reaching its glass transition temperature and prevent any chemical component (e.g., active material) from reacting undesirably. The drying may also proceed in two distinct steps, with an initial lower or may vary according to the composition of the electrode paste, thickness of the paste, etc.

As referenced above, the active layer 310 may be configured according to a desired inter-pellet porosity and overall porosity. Advantageously, by controlling porosity of the active layer (i.e., based on overall active material porosity and/or microstructure), cell performance characteristics relative to conventional electrodes when increasing thickness. For example, macro- or inter-pellet porosity may be controlled by using composite electrode pellets of a single mean size with defined size distribution, or by using composite electrode pellets having multiple mean sizes and varying relative quantities (i.e., bi-modal or polydisperse pellet size distribution). Inter-pellet porosity may also be impacted by composition of the conductive adhesion mixture and/or manufacturing of the electrode (e.g., without being heat pressed or calendered). Furthermore, micro- or intra-pellet porosity may be a function of pellet composition, manufacturing and/or processing thereof. By controlling electrode porosity, especially by controlling macro- or inter-pellet and manufacturing methods, greater flexibility is provided in achieving desired (e.g., higher) active material porosity, which provides for improved performance characteristics at high thickness as compared to conventional electrodes.

According to an exemplary embodiment, the composite electrode pellets have a porosity (i.e., micro or intra-pellet porosity) of less than approximately 45% (e.g., below between approximately 35% and 45%, or below or approximately equal to 41%). Those skilled in the art will recognize that porosity of the pellets, themselves, may be a function, for example, of component materials, relative quantities of component materials, pellet formation process, electrode formation process, etc. According to one exemplary embodiment, the pellets of the electrodes in Example 1 (discussed below) achieved a porosity of between approximately 35% and 45% (e.g., approximately 43%) using a rotor granulation process using a dry mixture of graphite powder at approximately 97 wt % and carbon black at approximately 3 wt % that is rotor granulated with a solution of binder at approximately 10 wt % and water at 90 wt %. It should be understood that this example is intended to be illustrative of how certain pellet porosities may be achieved but is not intended to be limiting.

According to an exemplary embodiment, the active layer 330 of the electrode has an overall porosity of greater than approximately 40% (e.g., greater than approximately 50%, between approximately 40% and 50%, or between approximately 50% and 60%). According to one exemplary embodiment, electrode Example 1 (discussed below) achieved a porosity of between approximately 50% and 60% (e.g., approximately 55%) using a monodisperse pellet size distribution (e.g., pellets having a size of between approximately 63 and 90 micrometers). According to one other exemplary embodiment, electrode Example 2 (discussed below) achieved a porosity of between approximately 40% and 50% (e.g., approximately 47%) using a poly disperse pellet size distribution (e.g., pellets having a size of less than approximately 45 micrometers provided at approximately 20 wt % and above approximately 212 micrometers at approximately 80 wt %). It should be understood that these examples are intended to be illustrative of how certain active material porosities may be achieved but are not intended to be limiting.

According to an exemplary embodiment, the active layer 330 includes electrode pellets that form less that approximately 90% by volume of the active layer, such as between approximately 60% and 90% by volume. For example, the electrode pellets may form approximately 75% to 85% by volume or approximately 70% to 80% by volume.

According to an exemplary embodiment, the active layer 330 includes a volume between the electrode pellets that form greater than approximately 10% by volume of the active layer, such as approximately 10% to 40% by volume. For example, the electrode pellets may form approximately 15% to 25% by volume or approximately 20% to 30% by volume.

According to an exemplary embodiment, the porosity of the electrode is configured or impacted according various considerations, including pellet size (e.g., if optimized for electrochemical reactions as discussed above), energy density, and power density. As described above, the length scale of the macroporosity is generally determined, absent pellet deformation, by pellet size since due to voids between the pellets and by the conductive adhesion mixture partially filling the voids. With increased porosity and increased performance characteristics as compared to conventional electrodes, the area energy density, in units of energy per area of electrode, may be increased as compared to an electrode prepared in a conventional manner. Further, processing of a pelletized electrode and battery may be simpler than for a conventional electrode or battery of comparable capacity, and may be easier to provide in thicker layers while being less prone to significant cracking issues.

According to an exemplary embodiment, the active material may be configured according to thickness. As discussed above, by increasing thickness of the active material, inactive materials of the battery or electrode (e.g., current collector, separator) may be used in lower quantities, while achieving comparable capacity, to reduce cost, weight, size, etc. of the battery.

According to an exemplary embodiment, the active layer has a thickness that is greater than the highest thicknesses typically used for conventional electrodes (i.e., greater than approximately 200 micrometers). For example, depending on the manufacturing process, the active layer of a given electrode may have a thickness of greater than approximately 400 micrometers. According to other exemplary embodiments, the thickness of the active layer may be configured according to other considerations including, for example, pellet size (e.g., the mean pellet size may less than approximately 20% of the active layer thickness to prevent localized capacity imbalance between facing electrodes of opposing polarity), charge/discharge rates (e.g., capacity utilization at high charge/discharge rates may drop for thicker electrodes), capacity utilization (e.g., high capacity utilization, for example above 70% at C/3, may be maintained up to certain thicknesses but may drop for increasing thicknesses), active material (e.g., thickness of active layer may be dependent upon the specific capacity of the active materials), and electrode balance (e.g., negative electrodes with greater capacity may be used, especially for carbonaceous or other low potential negative active materials, to prevent lithium plating).

According to an exemplary embodiment, the active layer of the negative electrode has a thickness of approximately 400 to 1000 micrometers (e.g., approximately 600 micrometers). For example, the negative active layer of electrode Examples 1 and 3 are approximately 600 micrometers and 580 micrometers, respectively, and the respective cells exhibited high capacity utilization.

According to an exemplary embodiment, the active layer of the positive electrode has a thickness of approximately 900 to 1500 micrometers (e.g., approximately 1100 micrometers). For example, the positive active layer of electrode Examples 1 and 3 are approximately 1100 micrometers and the respective cells exhibited high capacity utilization.

According to other exemplary embodiments, the thickness of the electrode may be selected or determined according to various other considerations, including the macroscopic conductivity of the electrodes, polarization of the electrolyte under normal charge and discharge operation, volume density of the electrochemically active materials in the overall electrode, density of the electrolyte in the overall electrode, electrolyte bulk ionic conductivity, microporosity structure, macroporosity structure, efficiency, ease of manufacture, and safety considerations.

According to other exemplary embodiments, the pellets (e.g., 170 or 270) may be joined together to form the electrodes 250, 260 in other manners, including, for example, by being disposed in a mold or form of desired shape and size, and then pressed or sintered together to form bulk electrodes. Heat and/or pressure are employed to raise the thermoplastic binder beyond its glass transition temperature, at which point adjacent pellets' polymeric binders may interact to form a continuous binder phase. Upon returning below the glass transition temperature, the new unitary structure is maintained which preserves the pellet-based structure involving both micro and macro porosity. For example, the binder material of adjacent pellets may be formed together into a bulk by using a heat press or heated rollers. The electrodes 250, 260 may further include or be coupled to a current collector 240 having a tab 242 configured to be coupled to other electrodes of like polarity.

According to still other exemplary embodiments, various methods may improve the electrode performance beyond changing pellet size that include, for example, use of a matrix, template or suspension material to define macroporosity, mechanically or chemically defining macroporosity post-electrode fabrication, and building electrodes bottom-up to have engineered macroporosity.

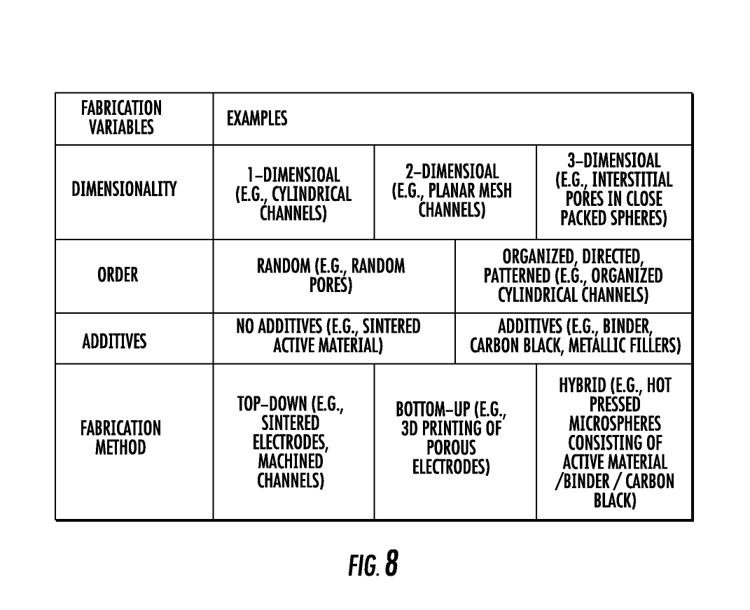

According to other exemplary embodiments, the electrodes may be formed according to other methods. Referring to the table in FIG. 8, there are several macroporosity fabrication variables that include, but are not limited to, dimensionality, order, additives, and fabrication methods. Other contemplated methods include, for example, the following:
A foam or other scaffold can be used as a negative mold with a predefined pore or channel structure that can have 1-, 2- or 3-dimensionally connected networks. These molds can be created by a variety of processes, including block copolymer self-assembly or commercial sponge/foam processes. This mold can be infiltrated with active material and removed (e.g., by dissolving or burning), leaving active material with a continuous channel network. This method of channel formation can be combined with other macroporosity formation methods (e.g., sintering, hot pressing, etc.).
Percolating networks of particle, rods, fibers, wires, or plates made of a sacrificial material may be formed spontaneously during processing when intermixed with the electrode materials. These sacrificial fillers may then be removed by dissolution in a solvent or via thermal oxidation to yield macroporosity.
Electrodes can be post-processed to large, cylindrical macroporosity, such as by machining, drilling, laser ablation, water jet cutting, or use of a patterned mold. This method of channel formation can be combined with other microscopic pore-channel formation (e.g., sintering, hot pressing, etc.).
A conductive mesh, foam or scaffold can be used as a base construct. The surfaces of this structure can be covered with a composite mixture (e.g., binder/conductive additive/active material) to form the electrode while maintaining the conductive scaffold's original pore geometry. Coatings can be accomplished using a variety of methods, such as dip coating, spray coating and paste coating with roll pressing.
Composite fibers (binder/conductive additive/active material) can be used rather than spherical constructs as a base for creating a porous electrode. Other forms, such as cubes, rectangular prisms, spheroids, “raspberry” clusters, rods, and plates may also be used.
Otherwise, methods and embodiments of forming pore structures that enable electrochemically active electrodes with a tunable proportion and distribution of electrolyte phase.

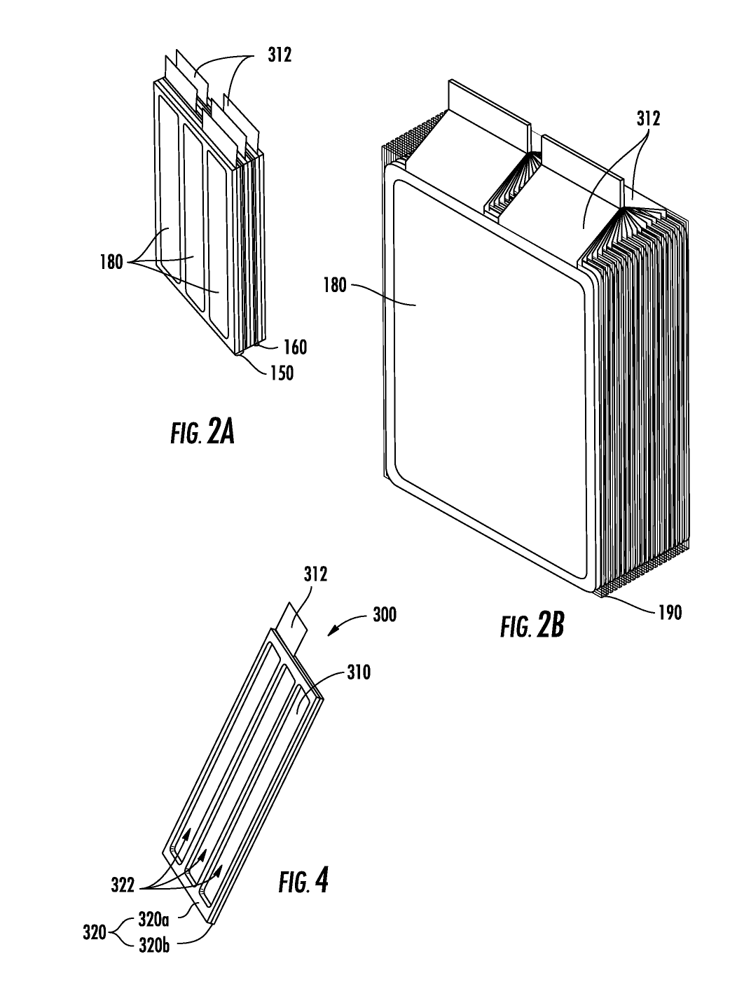

Referring to FIGS. 2B and 5-6A, according to an exemplary embodiment, electrode plates are stacked in an alternating fashion with separator films 190 and 290, respectively, interspersed there between. The separator films are formed such that they provide sufficient barriers between the electrodes of opposite polarity to prevent electrical contact between opposite polarity electrodes (i.e., prevent short circuit conditions between positive and negative electrodes), while facilitating ion diffusion or movement across it. The separator films may be added to the system in any fashion, including interspersing separator sheets, encapsulating fully formed electrodes, winding a separator around electrodes, and the like.

According to an exemplary embodiment, the separator films 190, 290 are porous films that allow for electrolyte to permeate the film, but do not allow for electrical conductivity between the electrodes. Separators can be made of many different materials, including polypropylene, polyethylene, glass fiber, polyvinylidene fluoride, polytetrafluoroethylene, polystyrene, fluorinated ethylene propylene, perfluoroalkoxy resin, cellulosic fiber, or a combination thereof. Separators may be formed with features or may have additives that provide self-sealing operation in the case of extreme heat generation. Separator films can be of varying thicknesses including from 5 micrometermicrometers to 1 millimeter, with films of 10 micrometers to 50 micrometers being preferable.

Referring to FIGS. 2B and 5-6A, according to an exemplary embodiment, stacks of electrodes 150, 160 and 250, 260, respectively, are connected in parallel by joining the current collectors 312 and 242, respectively, of like electrodes (i.e., having the same polarity). Any number of electrode pairs may be joined depending on design criteria, including performance requirements, manufacturability, safety, packaging or usage constraints, and the like. Joining encompasses any method of creating electrical contact between current collectors, including spot welding current collectors, ultrasonic welding, adding conductive materials between current collectors, using a screw or clamp, affixing current collectors to an existing conductive channel and the like. Additional connecting materials may include aluminum, copper, stainless steel, gold, silver, nickel, tungsten, titanium, a combination thereof or as a coating on a less expensive and incompatible material (e.g., nickel-coated steel). In doing so, one battery stack that has the equivalent voltage of a single electrode pair is created with the capacity of the entire set of electrode pairs.

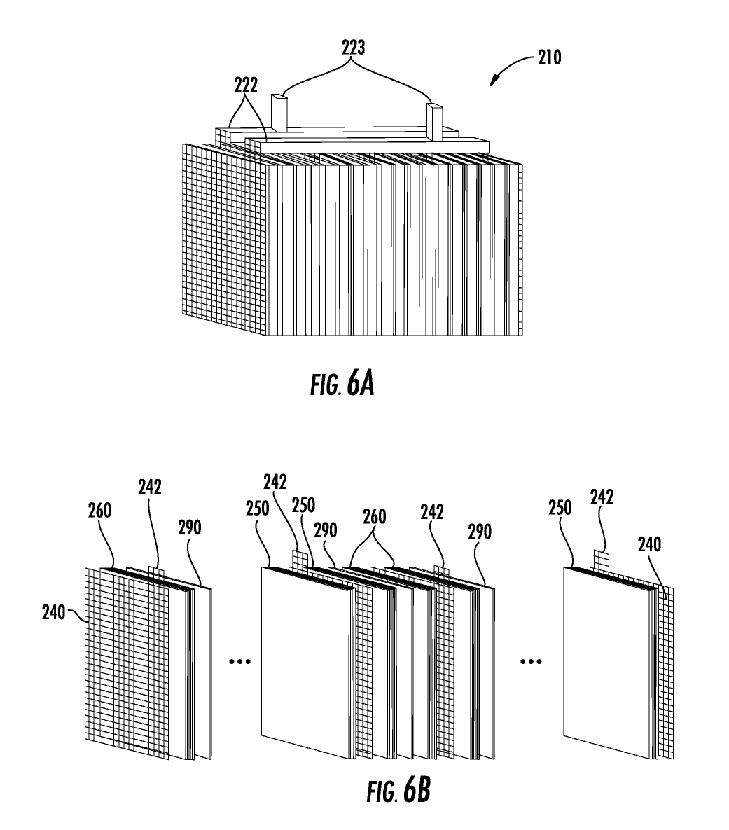

Referring to FIGS. 5 and 16, for example, according to an exemplary embodiment, electrode stacks (i.e., groupings of electrodes as shown in FIG. 5) or individual cells (e.g., cells as shown in FIG. 16) may then be joined in series to achieve higher voltage batteries. That is to say, the positive terminal from one stack or cell is then connected to the negative terminal from the another stack or cell. Any number of stacks cells may be joined depending on design criteria, including performance requirements, manufacturability, safety, packaging or usage constraints, and the like. Joining or connecting electrode stacks encompasses any method of creating electrical contact between current collectors, including spot welding current collectors, ultrasonic welding, adding conductive materials between current collectors, using a screw or clamp, using bus bars, affixing current collectors to an existing conductive channel and the like. To electrically joint or connect the electrode stacks or cells may be facilitated by using connecting materials may include aluminum, copper, steel, gold, silver, nickel, tungsten, titanium, a combination thereof or as a coating on a less expensive and incompatible material (e.g., nickel-coated steel). By connecting the cells or stacks in series, the end terminals of the stacks or cells have an equivalent voltage to the number of cells in series multiplied by the voltage of a single electrode pair. In one preferred embodiment, the number of stacks or cells are designed in such a way that the end terminals have voltages closely matched to typical voltages that are compatible with standard power electronics, such as 6V, 12V, 24V, 32V, 48V, 120V, 240V, 320V, 480V, and the like. A plurality of strings of cells in series may be combined to further increase the storage capacity of an array of cells.

According to an exemplary embodiment, the electrode stack is placed in a housing. Stacks can be placed in any orientation, including vertical and horizontal, depending on the ease of manufacturing, application of pressure to the electrodes, wiring requirements, weight distribution requirements, housing shape, cost, safety, etc.

According to an exemplary embodiment, a battery housing (e.g., 120, 220) is used to encapsulate the electrode stacks, and provide a hermetic seal to prevent water from entering the battery internals. The housing can be of any geometry that fits the electrodes and other battery internals. The housing may be comprised of several pieces that fit together, which are then bonded such as through heat, pressure, glue and the like. The housing can be made of any material or combinations of materials that provide sufficient mechanical stability (e.g., for battery chemistry, intended application or environment) and provide a barrier to water permeation. Examples of materials are polymers, such as polyethylene, polypropylene, polyvinylidene fluoride, polytetrafluoroethylene, polystyrene, fluorinated ethylene propylene, perfluoroalkoxy resin and the like, as well as combinations thereof. Additives may be added to polymers, such as to decrease water permeability, retard combustion, increase thermal conductivity, and the like. Other examples of materials include metals that have an inert, non-conductive coating, a metal-polymer laminate, or a polymer with a metallic coating. For example, as shown in FIGS. 15 and 16, a cell 400 may be configured as a pouch cell having, for example, a metal-polymer laminate casing 420 containing one or more electrode pairs of opposite polarity, a separator, and an electrolyte described. Terminals 412 extend from the casing 420 for electrical connection and may further be partially surrounded by the casing at lower regions, thereof. As shown in FIG. 16, the pouch cells 400 may be connected in series via terminals 412.

According to an exemplary embodiment, the battery housing 220, or a combination of multiple battery housings, may be dimensionally similar to conventional lead acid counterparts designed to be direct replacements for that chemistry. According to another exemplary embodiment, the housing is compatible and optimized for use onto server racks to enable the mounting of many batteries into a single structure.

According to an exemplary embodiment, two end terminals (e.g., 124, 224) are constructed that connect the negative and positive terminals inside the battery to an external interface. The external interface may be an extension of the terminals inside the battery, or a different set of terminals. The end terminals that are inside the battery housing may include aluminum, copper, stainless steel, gold, silver, nickel, tungsten, titanium, a combination thereof or as a coating on a less expensive and incompatible material (e.g., nickel-coated steel). The end terminals that are outside the battery housing may include any sufficient electrical conductor depending on various factors, such as cost, manufacturability, ability to connect or weld or join to the end terminals from the inside of the battery, ability to form a hermetic seal with the battery casing, etc.

According to an exemplary embodiment, the electrolyte is configured to behave as a medium for transferring ions between the positive and negative electrodes (e.g., 150, 160 and 250, 260, respectively). For example, the electrolyte may be aqueous having a lithium salt dissolved in a water solvent. According to an exemplary embodiment, the electrolyte is based on a lithium salt that may include, but is not limited to, LiPF₆, LiBF₄, LiAsF₆, LiI, LiCF₃SO₃, LiN(CF₃SO₂)₂, LiN(CF₃CF₂SO₂)₂, LiClO₄, LiB(C₂H₄)₂, (C₂H₅)₄NBF₄, (C₂H₅)₃CH₃NBF₄ or a combination thereof. This salt is dissolved in an organic alkyl carbonate solvent that may include, but is not limited to acetonitrile, γ-butyrolactone, diethyl carbonate, 1,2-dimethoxyethane, dimethyl carbonate, 1,3-dioxolane, ethyl acetate, ethylene carbonate, ethyl methyl carbonate, propylene carbonate, tetrahydrofuran or a combination thereof. In other exemplary embodiments, additives may be used to tune battery performance attributes, such as the stability of solid electrolyte interface formation, increased cycle life, decreased degradation of components, and decreased tendency to undergo side reactions. An example of such an additive is vinylene carbonate. In other exemplary embodiments, the solvent may be aqueous or the electrolyte may be an ionic liquid. In other exemplary embodiments, the ionic conductivity of the electrolyte is increased by non-chemical means, such as through increased temperature by an external source or by internal Joule heating.

According to an exemplary embodiment, electrolyte is added into the battery before the battery housing (e.g., 120, 220) is completely secured into a hermetic system. The battery internals have water removed therefrom, such as through vacuum heating or blowing hot, dry air through the system. Electrolyte is added in a water-free environment, such as in a dry room, glove box or a water-free, closed fluidic network that pumps electrolyte directly into the battery.

The battery may be applied, for example, to back-up power, remote installations, motive uses (e.g., passenger vehicles, commercial vehicles, industrial vehicles, low speed vehicles, marine vehicles, etc.), grid-level storage (e.g., coupled to buildings, renewable energy generators, ancillary services, etc.), and other large-scale uses. The concept may, however, be applied to smaller-scale uses, such as in drop-in replacements for lead-acid batteries (e.g., telecommunications, mining equipment, warehouse equipment, etc.). Further engineering of the electrode pore structure may lead to performance developments, for example, with charge/discharge rate capabilities, and energy density.

### Comparative Example #1

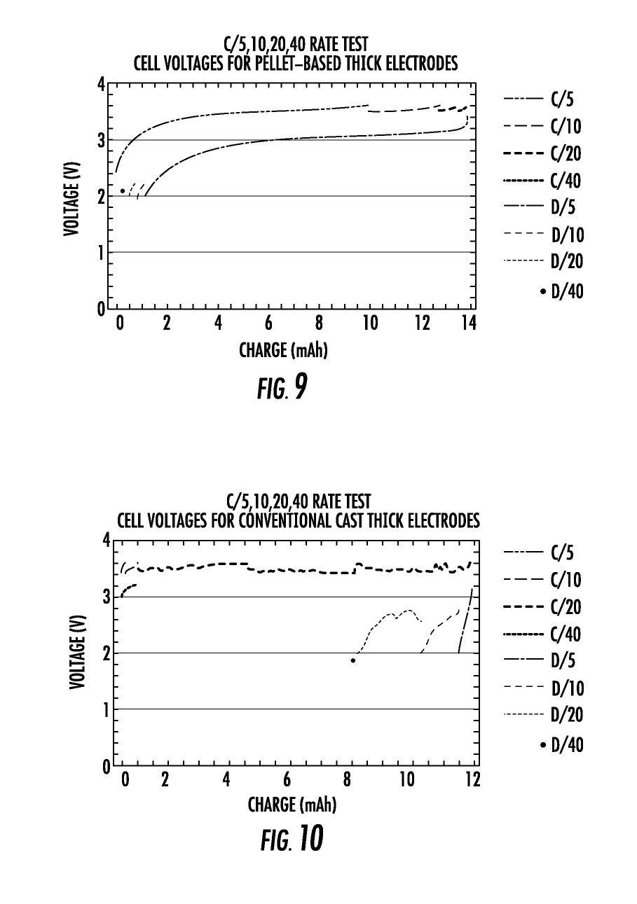

Experimental testing has shown improved discharge characteristics for a battery utilizing porous electrodes as described herein. FIGS. 9 and 10 are graphs depicting the voltage v. charge characteristics at various charge rates (e.g., C/5, C/10, C/20, and C/40) and discharge rates (e.g., D/5, D/10, D/20, D/40) for a battery utilizing electrodes according to an exemplary embodiment (FIG. 9) and for a battery utilizing conventional electrodes (FIG. 10). In this test, the cells were charged first at the fastest rate (C/5) until the upper voltage cutoff of 3.6V is reached. is the cells were subsequently charged at decreasing rates of C/10, C/20, and C/40, each being sustained until the 3.6V cutoff. After completing the C/40 charge, the cells are discharged in a similar manner, with the cell first discharged at the fastest rate of D/5. When the lower voltage cutoff of 2V is reached, the discharge is continued at decreasing rates of D/10, D/20, D/40. More particularly, FIG. 9 depicts the characteristics of a lithium-ion cell having 1 millimeter thick pellet-based positive and negative electrodes and a capacity of 17 mAh (i.e., theoretical total capacity based on the quantity of active material). The pellets forming the positive electrode are 190 micrometers in radius, including a 90 micrometer active layer and a 100 micrometer seed particle. The positive active layer includes a lithium iron phosphate active material, modified styrene-butadiene rubber binder, and carbon black conductive additive, while the seed particle is polyethylene. The pellets forming the negative electrode are 219 micrometers in radius, including a 119 micrometer active layer and a 100 micrometer seed particle. The negative active layer includes a graphite active material, modified styrene-butadiene rubber binder, and carbon black conductive additive, while the seed particle is polyethylene. The electrolyte is 1 M lithium hexafluorophosphate in a 1:1 blend of ethylene carbonate and dimethyl carbonate. FIG. 10 depicts the characteristics of a lithium-ion cell of similar chemistry having 0.8 millimeter thick cast, calendared electrodes and a capacity of 17 mAh (i.e., theoretical total capacity based on the quantity of active material).

The battery utilizing pellet-based electrodes shows improved useful capacity on charge and discharge at higher rates (e.g., C/5, D/5) which is represented by the higher accessible charge capacity the 5-hour charge and discharge rates. For example, cells having pellet-based electrodes according to an exemplary embodiment are able to access approximately 10 mAh of charge capacity at C/5, whereas cells having cast electrodes are able to access less than one-half of a mAh of charge capacity at C/5. On discharge, the cells having pellet-based electrodes according to an exemplary embodiment are able to access over 12 mAh of charge capacity, whereas cells having cast electrodes are able to access less than 1 mAh of charge capacity. Furthermore, attempts to charge the cast electrode at a rate of C/20 eventually lead to the shorting of the cell by plating of lithium metal dendrites, as seen in the extended charging of the cell under an sporadic voltage. This experimental data suggests that the active material of the pellet-based electrodes is more effectively utilized at higher electrode thicknesses than is the active material of cast electrodes. Additionally, the lower polarization of the pellet-based electrodes enables higher round-trip energy storage efficiencies, decreased Joule heating, and improved charge and discharge rate capabilities. Batteries having pellet-based electrodes also exhibited improved resistance to short-circuit conditions as compared to batteries having cast electrodes.

### Comparative Example #2

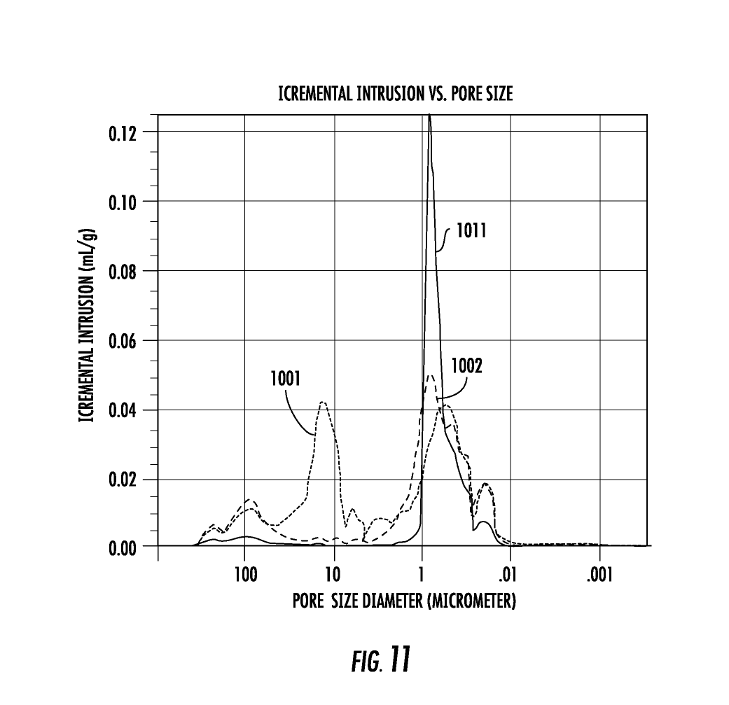

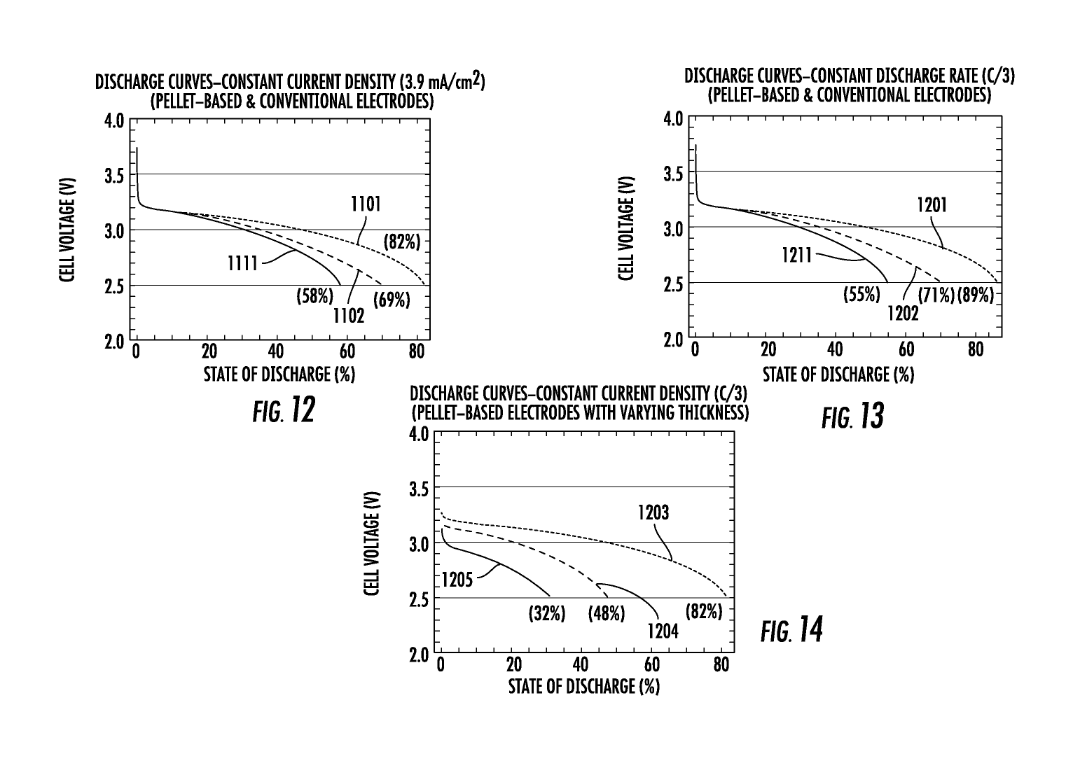

Mercury intrustion porosimetry testing has shown increased porosity for electrodes that have an active layer comprising composite electrode pellets as compared to conventionally formed electrodes. As shown in FIG. 11, overall electrode porosity is a function (e.g., summation) of the intra-pellet porosity (i.e., relatively small pores or voids within each pellet) and of the inter-pellet porosity (i.e., relatively large pores or voids between pellets). FIG. 11 also illustrates that the porosity of conventionally formed electrodes is generally concentrated at a single pore size. As shown in FIGS. 12 and 13, experimental data has further shown higher capacity utilization for batteries having relatively thick electrodes comprising composite electrode particles, as described herein, as compared to conventionally formed electrodes of similar thickness. This testing further illustrates higher capacity utilization correlating with higher porosity.

Anode pellets were formed directly from the constituent materials (graphite powder, electro-conductive grade carbon black powder, modified polystyrene-butadiene rubber aqueous binder solution in water) in a rotor granulation process. A dry mixture of 97 wt % graphite powder and 3 wt % carbon black was placed on an inverted conical surface disposed within a cylindrical chamber. As the conical surface was rotated at 225 RPM, a solution of 10 wt % binder, 90 wt % water was sprayed laterally onto the spinning mass of powder at a rate of 10 grams per minute. A stream of 50 degrees Celsius air flowing upwards in the gap between the rotating conical surface and the cylindrical chamber ensured that the powder was confined to the rotating upper surface of the cone. Upon contact with the aqueous binder, the dry powder mixture would aggregate into larger particles. The rolling motion of the particles on the smooth upper surface of the rotating cone then shaped the particles into spheres. After 50 minutes, the spray of binder was terminated and the spinning mass of now pelletized anode material was dried under a stream of 60 degrees Celsius air flowing at 70 cubic feet per minute. Thus spherical composite anode pellets of 157 micrometer average pellet diameter were produced.

Cathode pellets were formed directly from the constituent materials (lithium iron phosphate powder, electro-conductive grade carbon black powder, modified polystyrene-butadiene rubber aqueous binder solution in water) in a rotor granulation process. A dry mixture of 89 wt % lithium iron phosphate powder and 11 wt % carbon black was placed on an inverted conical surface disposed within a cylindrical chamber. As the conical surface was rotated at 400 RPM, a solution of 10 wt % binder, 90 wt % water was sprayed laterally onto the spinning mass of powder at a rate of 27 grams per minute. A stream of 50 degrees Celsius air flowing upwards in the gap between the rotating conical surface and the cylindrical chamber ensured that the powder was confined to the rotating upper surface of the cone. Upon contact with the aqueous binder, the dry powder mixture would aggregate into larger particles. The rolling motion of the particles on the smooth upper surface of the rotating cone then shaped the particles into spheres. After 60 minutes, the spray of binder was terminated and the spinning mass of now pelletized anode material was dried under a stream of 60 degrees Celsius air flowing at 70 cubic feet per minute. Thus spherical composite anode pellets of 146 micrometer average particle diameter were produced.

Both cathode and anode pellets were passed through a series of sieves with openings of 212 micrometers, 90 micrometers, 63 micrometers, and 45 micrometers. Samples of the following sieve cuts were obtained: Pellets larger than 212 micrometers, pellets between 90 and 212 micrometers, pellets between 63 and 90 micrometers, pellets between 45 and 63 micrometers, and pellets smaller than 45 micrometers.

Based on measured active layer porosity (discussed below) and pellet volume, porosity of the electrode pellets was calculated to be between approximately 40 and 41 vol %.

Composite anode grids were made of an expanded copper foil formed of 125 micrometer foil slitted and expanded to have an open area of roughly 70%. The foil was thermally bonded to a 500 micrometer thick frame of high density polyethylene in a hot press set at 200 degrees Celsius. A steel spacer in the hot press acted as a hard stop to set the final grid thickness at 600 micrometers. The resulting laminate structure had a windowed HDPE frame bonded to a uninterrupted expanded copper substrate.

Composite cathode grids were made of an expanded aluminum foil formed of 125 micrometer foil slitted and expanded to have an open area of roughly 70%. The foil was thermally bonded to a 1000 micrometer thick frame of high density polyethylene in a hot press set at 200 degrees Celsius. A steel spacer in the hot press acted as a hard stop to set the final grid thickness at 1100 micrometers. The resulting laminate structure had a windowed HDPE frame bonded to a uninterrupted expanded aluminum substrate.

Formation of the first example anode (Example 1) having a monodisperse pellet size distribution is described as follows. The 63-90 micrometer anode pellets, carbon black, polypropylene flock, binder, and water were combined in ratios of 61 wt %, 1.9 wt %, 0.2 wt %, 0.9 wt %, and 36 wt %, respectively. After kneading the mixture, the resulting paste was pasted onto the anode composite grid. A trowel was run across the composite grid surface to remove excess paste, resulting in an even electrode thickness.

Formation of the first example cathode (Example 1) having a monodisperse pellet size distribution is described as follows. The 63-90 micrometer cathode pellets, carbon black, polypropylene flock, binder, and water were combined in ratios of 59 wt %, 1.9 wt %, 0.2 wt %, 0.9 wt %, and 38 wt %, respectively. After kneading the mixture, the resulting paste was pasted onto the cathode composite grid. A trowel was run across the composite grid surface to remove excess paste, resulting in an even electrode thickness.

Both anode and cathode pasted grids were dried under argon at 70 degrees Celsius for 24 hours.

The porosity and pore size distribution of an electrode fabricated this way was measured by mercury intrusion porosimetry. The overall porosity of the Example 1 electrode was measured to be 55 vol %, which, as shown in FIG. 11, is concentrated generally at two pore sizes of approximately 1 micrometer (reflecting micro- or intra-pellet porosity) and approximately 10 micrometers (reflecting macro- or inter-pellet porosity).

Formation of a second example anode (Example 2) having bi-modal pellet size distribution is described as follows. The under-45 micrometer anode pellets, over-212 micrometer anode pellets, carbon black, polypropylene flock, binder, and water were combined in ratios of 12 wt %, 49 wt %, 1.9 wt %, 0.2 wt %, 0.9 wt %, and 36 wt %, respectively. After kneading the mixture, the resulting paste was pasted onto the anode composite grid. A trowel was run across the composite grid surface to remove excess paste, resulting in an even electrode thickness.

Formation of a second example cathode (Example 2) having bi-modal pellet size distribution is described as follows. The under-45 micrometer cathode pellets, over-212 micrometer cathode pellets, carbon black, polypropylene flock, binder, and water were combined in ratios of 12 wt %, 47 wt %, 1.9 wt %, 0.2 wt %, 0.9 wt %, and 38 wt %, respectively. After kneading the mixture, the resulting paste was pasted onto the cathode composite grid. A trowel was run across the composite grid surface to remove excess paste, resulting in an even electrode thickness.

The porosity and pore size distribution of an electrode fabricated this way was measured by mercury intrusion porosimetry. The overall porosity of the Example 2 electrode was measured to be 47 vol %, which, as shown in FIG. 11, is concentrated at a first size of approximately 1 micrometer (reflecting micro- or intra-pellet porosity) and is distributed across larger pore sizes (reflecting macro- or inter-pellet porosity with the under-45 micrometer at least partially filling voids between the over-212 micrometer cathode pellets).

Formation of a first comparative example (Comparative Example 1) anode having a conventional design is described as follows. Raw graphite powder, carbon black, polypropylene flock, binder, and water were kneaded to produce an anode paste with the same fundamental composition as found in Examples 1 and 2, without the formation of any pellets. After kneading the mixture, the resulting paste was pasted onto the anode composite grid. A trowel was run across the composite grid surface to remove excess paste, resulting in an even electrode thickness.

Formation of a first comparative example cathode (Comparative Example 1) having a conventional design is described as follows. Raw lithium iron phosphate powder, carbon black, polypropylene flock, binder, and water were kneaded to produce a cathode paste with the same fundamental composition as found in Examples 1 and 2, without the formation of any pellets. After kneading the mixture, the resulting paste was pasted onto the cathode composite grid. A trowel was run across the composite grid surface to remove excess paste, resulting in an even electrode thickness.

The porosity and pore size distribution of an electrode fabricated this way was measured by mercury intrusion porosimetry. The overall porosity of the Comparative Example 1 electrode was measured to be 37 vol %, which, as shown in FIG. 11, is concentrated generally at a single pore size of approximately 1 micrometer, which correlates closely to the micro- or intra-pellet porosity of Example 1 and 2 electrodes. The slight concentration of pores at approximately 100 micrometers is believed to represent electrode cracking.

As shown in FIG. 11, electrode Examples 1 and 2 having mono-disperse and bi-modal electrode pellet size distribution, respectively, exhibit higher overall porosity as compared to the electrode Comparative Example 1 having conventional design.

Formation of first and second battery cells (Examples 1 and 2) and first comparative example (Comparative Example 1) battery cells is described as follows. In each case, the anode, a non-woven glass mat separator, and the cathode were saturated with a non-aqueous electrolyte composed primarily of ethylene carbonate, dimethyl carbonate, and propylene carbonate with a lithium hexafluorophosphate salt. The stack of the anode, separator, and cathode, in that order, were stacked and placed within a cylindrical perfluoroalkoxy polymer housing, with the metal current collectors of the anode and cathode disposed outward. Stainless steel rods acted as current leads to the electrodes and were sealed against the polymer housing with swaged fittings to form a hermetic enclosure.

The anodes and cathodes fabricated for Examples 1 and 2 and Comparative Example 1 were then assembled into battery cells. Each cell was fully charged and then discharged under two different conditions. FIG. 12 shows the discharge voltage curves for the three cells discharged under a constant current density of 3.9 mA/cm². Curve 1101 represents cell Example 1 (i.e., electrodes with monodisperse pellet size distribution), curve 1102 represents cell Example 2 (i.e., electrodes with bi-modal pellet size distribution), and curve 1111 represents cell Comparative Example 1 (i.e., conventional electrodes). Discharge was terminated at a lower voltage cutoff of 2.5V. FIG. 12 illustrates that the cells demonstrate a positive correlation of increasing porosity and increasing capacity utilization under discharge.

FIG. 13 shows the discharge voltage curves for the three cells discharged under a constant C-Rate discharge, where each cell is discharged at a current necessary to discharge the entire theoretical capacity in 3 hours. Curve 1201 represents cell Example 1 (i.e., electrodes with monodisperse pellet size distribution), curve 1202 represents cell Example 2 (i.e., electrodes with bi-modal pellet size distribution), and curve 1211 represents cell Comparative Example 1 (i.e., conventional electrodes). FIG. 13 illustrates that the cells demonstrate a positive correlation of increasing porosity and increasing capacity utilization under discharge.

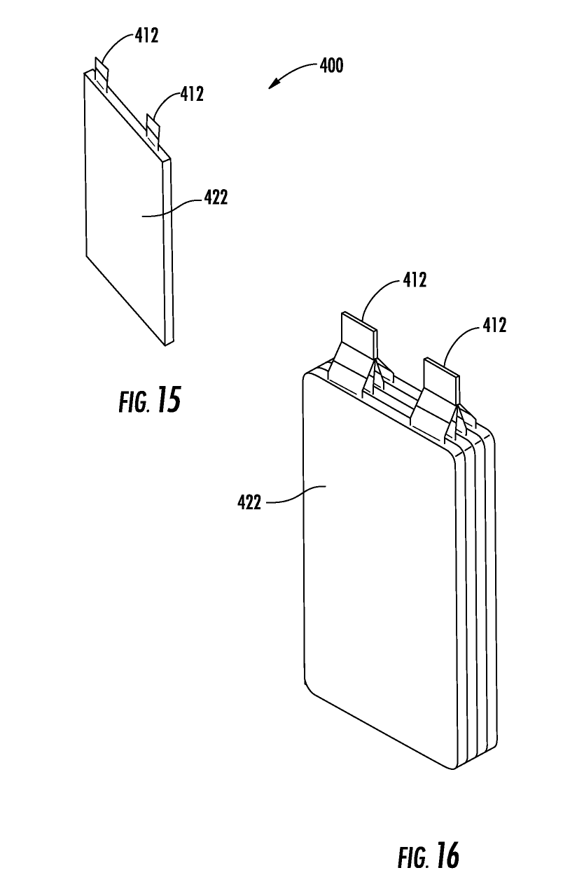

Additional composite anode and cathode grids were fabricated as described above, but with varying anode thicknesses of 580 micrometer (Example 3), 900 micrometer (Example 4), and 1100 micrometer (Example 5) and varying cathode thicknesses of 1100 micrometer (Example 3), 1800 micrometer (Example 4), and 2100 micrometer (Example 5). Electrodes were produced with these grids in the same manner described above in Example 1. Three cells were assembled by pairing the 580 micrometer anode and 1100 micrometer cathode (cell Example 3), 900 micrometer anode and 1800 cathode (cell Example 4), and 1100 micrometer anode and 2100 micrometer cathode (cell Example 5) in the same manner described above for cell Example 1. Cell Examples 1, 2, and 3 were measured at a constant C/3 C-Rate as described for Example 1 with discharge voltage curves are show in FIG. 14. Curve 1203 represents cell Example 3 curve 1204 represents cell Example 4, and curve 1205 represents cell example 5. FIG. 14 illustrates that high capacity utilization (e.g., above approximately 70%) is maintained for high electrode thicknesses but may diminish with further increased thickness. Capacity utilization is generally defined as actual utilization of electrode capacity as compared to theoretical capacity based on the specific capacity and amount of active material provided.

As utilized herein, the terms “approximately,” “about,” “substantially,” and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the dual gear assemblies as shown in the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A lithium-ion battery comprising:
an electrode pair having a first electrode and a second electrode, wherein the first electrode and the second electrode are of opposite polarity;
an electrolyte configured to allow movement of ions between the first electrode and the second electrode; and
a separator between the first electrode and the second electrode;
wherein the first electrode comprises:
an active layer comprising a plurality of composite electrode pellets, the composite electrode pellets each being non-hollow and comprising an active material and a binder material; and
a current collector;
wherein the active layer is provided on a first side of the current collector and has an overall porosity that is greater than approximately 40% by volume, the overall porosity including both intra-pellet porosity and inter-pellet porosity.

2. The lithium-ion battery according to claim 1, wherein each composite electrode pellet has a porosity below approximately 45%.

3. The lithium-ion battery according to claim 2, wherein the active layer has a volume, and between approximately 15% and 40% of the volume of the active layer is between the composite electrode pellets.

4. The lithium-ion battery according to claim 1, wherein the active layer has a volume, and between approximately 15% and 40% of the volume of the active layer is between the composite electrode pellets.

5. The lithium-ion battery according to claim 1, wherein the active layer has a thickness greater than approximately 400 micrometers.

6. The lithium-ion battery according to claim 1, wherein the first electrode is a negative electrode, and the active material is graphite.

7. The lithium-ion battery according to claim 1, wherein the first electrode is a positive electrode, and the active material is LiFePO₄.

8. The lithium-ion battery according to claim 1, wherein the active material forms between approximately 60 wt % and 98 wt % of each composite electrode pellet, and the binder material forms less than approximately 15 wt % of each composite electrode pellet.

9. The lithium-ion battery according to claim 1, wherein the overall porosity of the active layer is greater than approximately 50%.

10. The lithium-ion battery according to claim 1, wherein the composite electrode pellets have a mean diameter of between approximately 25 and 250 micrometers.

11. The lithium-ion battery according to claim 10, wherein the mean diameter of the composite electrode pellets has a standard deviation that is less than approximately half the mean diameter.

12. The lithium-ion battery according to claim 1, wherein the composite electrode pellets have a mean diameter of greater than approximately three times the mean diameter of particles of the active material.

13. The lithium-ion battery according to claim 1, wherein the plurality of composite electrode pellets have a multi-modal size distribution.

14. The lithium-ion battery according to claim 1, wherein the active layer comprises a second binder material and a second conductive material, which cooperatively conductively couple the composite electrode pellets to each other.

15. The lithium-ion battery according to claim 14, wherein the active layer comprises a mechanical floc.

16. The lithium-ion battery according to claim 1, wherein the first electrode further comprises a second active layer comprising a plurality of composite electrode pellets, the composite electrode pellets being non-hollow and having an active material and a binder material;
wherein the second active layer is provided on a second side of the current collector and has a porosity of greater than approximately 40%.

17. The lithium-ion battery according to claim 16, wherein the lithium-ion battery comprises more than one of the electrode pair, and wherein the first electrodes and the second electrodes of the electrode pairs are stacked in alternating fashion.

18. The lithium-ion battery according to claim 1, wherein the lithium-ion battery comprises more than one of the electrode pair, and wherein the first electrodes and the second electrodes of the electrode pairs are stacked in alternating fashion.

19. The lithium-ion battery according to claim 1, wherein the first electrode is a negative electrode, the second electrode is a positive electrode, the active material of the negative electrode comprises graphite, and a capacity of the negative electrode is more than approximately 10% greater than a capacity of the positive electrode.

20. The lithium-ion battery according to claim 1, wherein the active layer has a thickness, and the composite electrode pellets have a mean diameter that is less than approximately 20% of the thickness of the active layer.

21. An electrode for a lithium-ion battery, comprising:
an active layer comprising a plurality of composite electrode pellets, the composite electrode pellets each being non-hollow and comprising an active material and a binder material; and
a current collector;
wherein the active layer is provided on a first side of the current collector and has an overall porosity that is greater than approximately 40% by volume, the overall porosity including both intra-pellet porosity and inter-pellet porosity.

22. The electrode according to claim 21, wherein each composite electrode pellet has a porosity below approximately 45%.

23. The electrode according to claim 22, wherein the active layer has a volume, and between approximately 15% and 40% of the volume of the active layer is between the composite electrode pellets.

24. A method for manufacturing an electrode for a lithium-ion battery, the method comprising:
rotor granulating an active material and a binder material to form a plurality of composite electrode pellets that are non-hollow;
mixing the composite electrode pellets with a binder material, a conductive additive, and a solvent to form an electrode paste;
providing a current collector;
providing the electrode paste on a first side of the current collector; and
curing the electrode paste on the first side of the current collector to form an electrode with an active layer that comprises at least a portion of the composite electrode pellets;
wherein the active layer has an overall porosity that is greater than approximately 40% by volume, the overall porosity including both intra-pellet porosity and inter-pellet porosity.

25. The method according to claim 24, further comprising providing the electrode paste on a second side of the current collector, and curing the electrode paste on the second side of the current collector to form the electrode with a second active layer the comprises at least a portion the plurality of composite electrode pellets;
wherein the second active layer has an overall porosity that is greater than approximately 40% by volume, the overall porosity including both intra-pellet porosity and inter-pellet porosity.

26. The method according to claim 24, wherein the composite electrode pellets are not heat pressed on the current collector.
